(19) United States
(12) Patent Application Publication
(10) Pub. No.: US 2005/0120694 A1
(43) Pub. Date: Jun. 9, 2005

(54) Universal corn head mounting system

(76) Inventor: Marion Calmer, Alpha, IL (US)

Correspondence Address: LAW OFFICE OF JAY R. HAMILTON, PLC., 331 W. 3RD ST., NEW VENTURES CENTER SUITE 100, DAVENPORT, IA, 52801, US

(21) Appl. No.: 11/001,764

(22) Filed: Dec. 1, 2004

Related U.S. Application Data
(63) Continuation-in-part of application No. 09/827,563, filed on Apr. 6, 2001.

(51) Int. Cl. A01D 34/03

(52) U.S. Cl. 56/14.7

(57) ABSTRACT

The corn head apparatus and method of manufacture claimed and disclosed herein allows the user to disconnect the choice of corn head manufacturer from the choice of combine. As disclosed herein, manufacturing productivity is increased by substantially standardizing the methodology and apparatus necessary to attach combine heads to different combine makers. Furthermore, the corn harvesting unit and the attachment modifications for connection to the threshing unit provide an improved flow of material from the row to the threshed grain in the combine. These modifications of structure and the resultant spatial changes to the variety of the conveying systems used from the row unit through the combine increase harvest efficiency. The disclosed spatial relationship between the conveying systems permits improved flow and flow rates.

### CROSS REFERENCE TO RELATED APPLICATIONS

I, Marion Calmer, residing in Alpha, Ill. and being a United States citizen, do herein in this patent application disclose and claim the apparatus and method of using my invention “Universal Corn Head Mounting System”. I do also herein state and claim that this application is a continuation-in-part of U.S. patent application Ser. No. 09/827,563 filed Apr. 6, 2001 entitled “Strategic Spatial Realignment for Attaching Cornheads to Combines.” The patent application Ser. No. 09/827,563 is incorporated by reference herein.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

(Not Applicable)

### FIELD OF THE INVENTION

This invention relates to corn harvesting machinery, specifically combine corn heads and the methods and apparatus of mounting combine corn heads to combines.

### BACKGROUND OF THE INVENTION

This invention relates to corn harvesting machinery and more particularly the corn row unit of the corn head commonly used with modern self-propelled combines. Each corn head is composed of a frame for attachment of both the rotating and stationary components of the corn head. The multiple row units are attached to the corn head frame. Each row unit contains a row crop divider, a row unit hood, gathering/conveying chain(s), two stripper plates, two stalk rolls, a row unit frame, and a gearbox. The gearbox powers the row unit for gathering corn plants then stripping, separating and conveying ears of corn from the corn plant. The harvested material is collected by the cross auger and trough for collection and delivery by the cross auger to the feeder house. The combine feeder house contains a chain slat undershot conveying system for retrieving material from said corn head and delivering harvested material to the threshing system, of which all are existing art.

The crop dividers in combination with the gathering chain(s) and stripper plates as in the prior art have always retrieved the crop from near ground level into the row units. The stripper plates in combination with the stalk rolls will strip and separate the ears with minimal amounts of MOG (material other than grain). Said gathering chain(s) then feed the heterogeneous material (ears and mog) into the cross auger and trough. The cross auger is located between the exit point of the row units and in front of the feeder house opening. The cross auger then delivers this material to the feeder house for conveying to the combine for ultimate threshing and separating.

As disclosed and fully discussed in patent application Ser. No. 09/827,563, this results in power being required to move this crop on an inclined plane at three stages for the conveying process. This first stage of the conveying process is in the row unit where there is adequate power and crop engagement for elevating the crop from near ground level into the cross auger and trough. The cross auger has flighting on it, which applies power to the material horizontially in the cross auger trough, thus having changed the direction of flow of the material, which was previously in parallel with direction of material flow through the combine and row unit, to a lateral or cross ways movement to the exit area of the cross auger. This material is then fed into the third stage of the conveying process, the feeder house of the combine. Thus, the second stage of movement of the crop is a result of being contained against the floor and vertical side of the cross auger trough. The two lateral sections of the cross auger are oppositely wound and meet in the middle so that the horizontal movement of the crop from the right side and the left side of said cross auger meet and create a mass to be transferred to the feeder house.

At the entrance to the feeder house, the back vertical wall of the cross auger trough, in front of the feeder house, is open so that the material may be fed from the cross auger floor into the feeder house and most of the movement or force imparted to the mass of the material assembled at the entrance is in the forward direction towards the feeder house.

In the past thirty years there have been new developments in both agricultural science and harvesting technology. In most cases, yields have nearly doubled through improved genetics, fertilization, populations and row spacings. Additionally, harvesting machines are much larger with increased horsepower and ground speeds which require corn headers with more row units. These two factors in combination have significantly increased the flow rate and mass of material being delivered by said corn head and retrieved by said feeder house to a level that can now cause build up, back feeding, tossing of MOG onto the row unit covers, fluff, tossing of ears onto the ground, and resultant plugging in the cross auger feeder house area.

During this same time period, it has become typical in the sale and manufacturing of agricultural harvesting equipment for a farmer to buy both a combine and corn head or platform built by the same manufacturer. Additionally, corn heads and platforms built by a manufacturer do not fit on earlier or later models of combines. This effectively limits the purchaser's ability to optimize performance and increases his economic switching costs should he want to trade for a combine built by a different manufacturer than he currently owns while preferring to keep his existing corn head or platform. If the purchaser attempts to choose one brand of head to use with another brand of combine, significant engineering and mechanically modification can be necessary.

Finally, agricultural equipment manufacturers have chosen different platforms for corn separation i.e. rotary systems compared to threshing cylinders. As a result, the user wishing to adopt the separation technology offered by one manufacturer's combine, may also have to purchase a head built by the same manufacturer. Having to purchase the same brand of corn head and combine inevitably results in trade-offs and costs for the user and or purchaser.

### BRIEF SUMMARY OF THE INVENTION

The present inventor as the exclusive owner and licensee of U.S. Pat. No. 5,555,704 covering single gathering chain row unit which provides the only viable technology allowing users to harvest corn in planted in fifteen (15) inch row widths, finds the present state of the art untenable and discloses and claims a method and apparatus herein to allow farmers to choose the best corn head or platform for their needs independent of the combine used by the farmer. It is therefore an object of this invention to teach a universal method and apparatus for assembly and attachment of combine corn heads to combines.

It is another objective of the present invention to provide a method and apparatus allowing farmers to use heads and platforms manufactured by one manufacturer with combines manufactured by another manufacturer.

It is another object of this invention to improve upon and incorporate the disclosure found in U.S. patent application Ser. No. 09/827,563 of which this application is a continuation in part. As taught by patent application Ser. No. 09/827,563, the invention provides for improved corn head performance i.e. better material flow and less congestion and more even feeding of the harvested crop to the feeder house conveyor. Strategic re-alignment or changes to the spatial relationship of the exit area of the corn header and the retrieving area of the combine feeder house so as to decrease the inclined plane during this flow

It is also an objective of the present invention to improve the spatial arrangement between the corn head or platform and the feeder house of the combine to thereby reduce inhibition of the flow of grain materials into the combine.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is a plan view of a combine with a corn head attached.

FIG. 2 is a top view of the corn head, cross auger and feeder house row units.

FIG. 3 is a sectional view A-A of the row unit, cross auger, trough, feeder house and conveyor of the prior art.

FIG. 4 is a sectional view A-A of the row unit, cross auger, trough, feeder house, and conveyor of the invention as disclosed in Patent Application 9,

FIG. 4a is a modification of the tray or trough in FIG. 4

FIG. 5 is a sectional view A-A of another embodiment of the invention.

FIG. 6 is a sectional view A-A of a further embodiment of the invention.

FIG. 7 is an end view of the header of this invention showing the filler plate and a different fastener between the header and the feeder house.

FIG. 8 is an isometric view of the universal corn head frame from the row unit attachment side.

FIG. 9 is an isometric view of the universal corn head frame from the combine attachment side.

FIG. 10 is an isometric view of one embodiment of the vertical spacer for the universal corn head mounting system.

FIG. 11 is a front view of embodiment shown in FIG. 10.

FIG. 12 is an end view of the embodiment shown in FIG. 10.

FIG. 13 is an isometric view of the side filler plate used with the embodiment shown in FIG. 10.

FIG. 14 is a front view of the side filler plate shown in FIG. 13.

FIG. 15 is an end view of the side filler plate shown in FIG. 13.

FIG. 16 is an isometric view of the back support plate used with the embodiment shown in FIG. 10.

FIG. 17 is a front view of the back support plate used with the embodiment shown in FIG. 10.

FIG. 18 is a side view of the back support plate used with the embodiment shown in FIG. 10.

FIG. 19 is an isometric view of another embodiment of the vertical spacer for the universal corn head mounting system.

FIG. 20 is a front view of the embodiment shown in FIG. 19 without brackets.

FIG. 21 is a side view of the embodiment shown in FIG. 19 without brackets.

FIG. 22 is an isometric view of the side filler plate used with the embodiment shown in FIG. 19.

### DETAILED DESCRIPTION

Listing of the Elements

| Description | Number |
|---|---|
| Corn head frame (or header) | 250 |
| Corn head frame top beam | 10 |
| Corn head frame lower beam | 12 |
| Corn head frame breast plate | 15 |
| Universal frame feeder house opening | 20 |
| Universal frame feeder house tower | 22 |
| Corn head frame tower | 26 |
| Corn head frame tower cross | 28 |
| Vertical spacer, embodiment 1 | 240 |
| Vertical spacer recessed mount | 24 |
| Vertical spacer, embodiment 2 | 245 |
| Vertical spacer | 255 |
| Spacer brace | 30 |
| Spacer clip | 35 |
| Preformed spacer cover | 40 |
| Preformed back wall plate | 45 |
| Side filler plate | 55 |
| Side filler plate support | 56 |
| Side filler mounting plate | 58 |
| Knee braces | 60 |
| Side Filler plate horizontal mount | 61 |
| Side filler plate vertical mount | 62 |
| Side frame plate | 63 |
| Foot plate | 70 |
| Row unit | 80 |
| Row unit dividers | 90 |
| Gathering chain paddles | 110 |
| Gathering chains | 120 |
| Stripper plates | 130 |
| Snapping Slots (Ear separation chambers) | 140 |
| Row unit covers | 150 |
| Stalk (snapping) rolls | 160 |
| Cross Auger Trough | 200 |
| Cross Auger | 220 |
| Cross Auger Flighting | 230 |
| Combine Feeder house chain | 320 |
| Combine Feeder house | 340 |

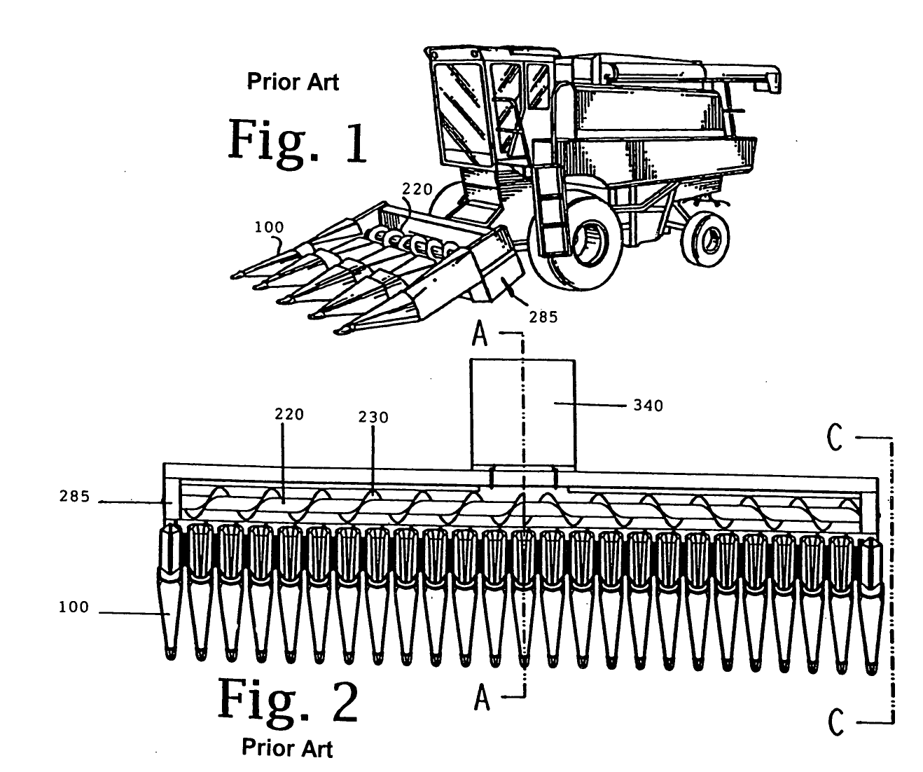

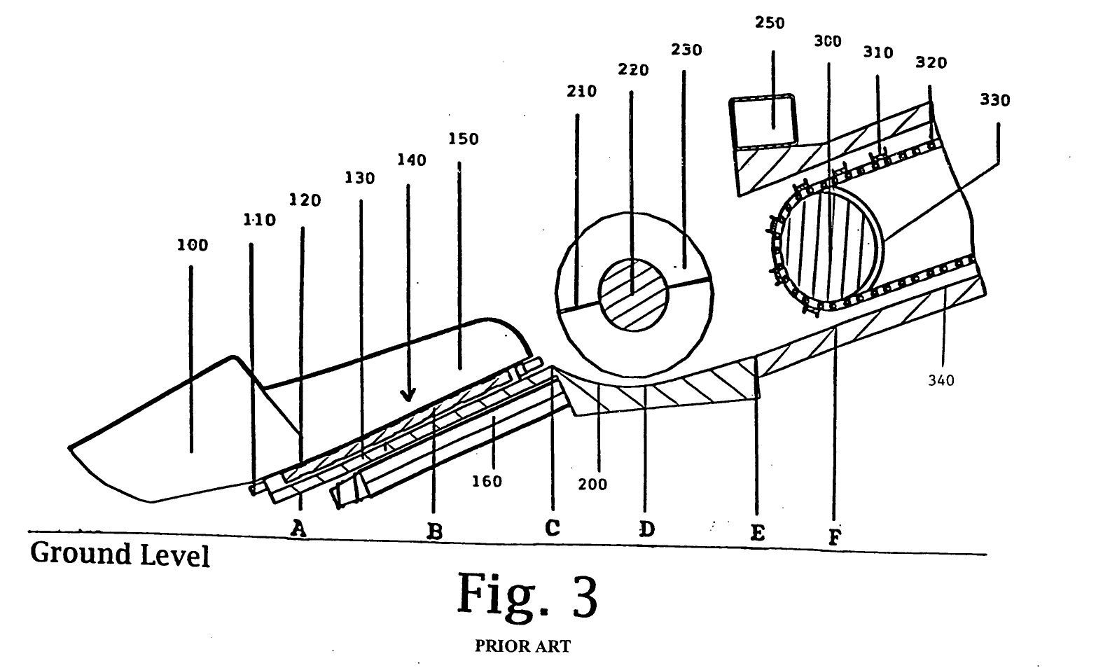

The operation of corn heads incorporating this invention are similar to that of the operation of corn heads of the prior art as illustrated in FIGS. 1, 2, and 3. In FIGS. 3, 4, 4a, 5 and 6 the corn stalks are engaged by the gathering chains 120 guided into the snapping slots 140 formed by stripper plates 130. The snapping rolls 160 pull the corn stalks through the snapping slots 140 an the ears are removed from the stalks, point B, as they come into engagement with the stripper plates 130. The ears are then carried rearwardly by the gathering chain fingers 110 and deposited in the trough 200 that contains the auger 220 flighting 230. The power to drive the gathering chains 120 and the snapping rolls 160 is provided from a main shaft through a gear box as described in the prior art. As shown in FIG. 3, the crop must proceed from point A, up the inclined plane by the power imparted to it by the gathering chains 120 through point B to point C where the crop is deposited into the auger trough 200 for lateral movement to the exit point E area of the auger through 200 by the cross auger 220 having flighting 230 thereon. The primary movement of material by the flighting is horizontal so energy is imparted to the material i.e., the ears of the corn plus MOG primarily rearwardly and laterally. The auger trough 200 has its vertical rear side removed when it is opposite the feeder house 340 and the feeder house chain 320. Thus the material has had some energy imparted to it from the gravitational movement from point C to point D, which is the low point of the travel of the material in the cross auger trough 200. Now the material must be, as shown in FIGS. 3, 4, 4a, 5, and 6, forced by the cross auger from position D over the edge of the cross auger trough E and to the retrieving point F of the feeder house 340. The feeder house chain 320 can not be too close to the cross auger flighting 230 because of the interference which would result from two parts moving in opposite directions and powered for such movement. Thus the material which has accumulated at the exit point is forced laterally, i.e., rearwardly up the inclined plane by the motions of the flighting 230.

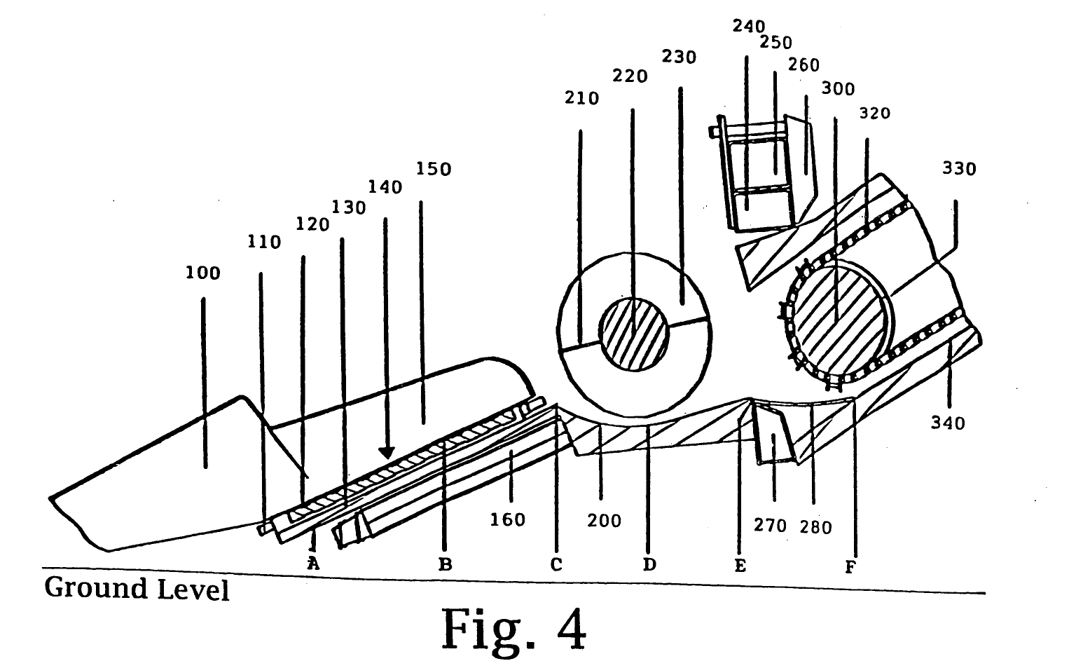

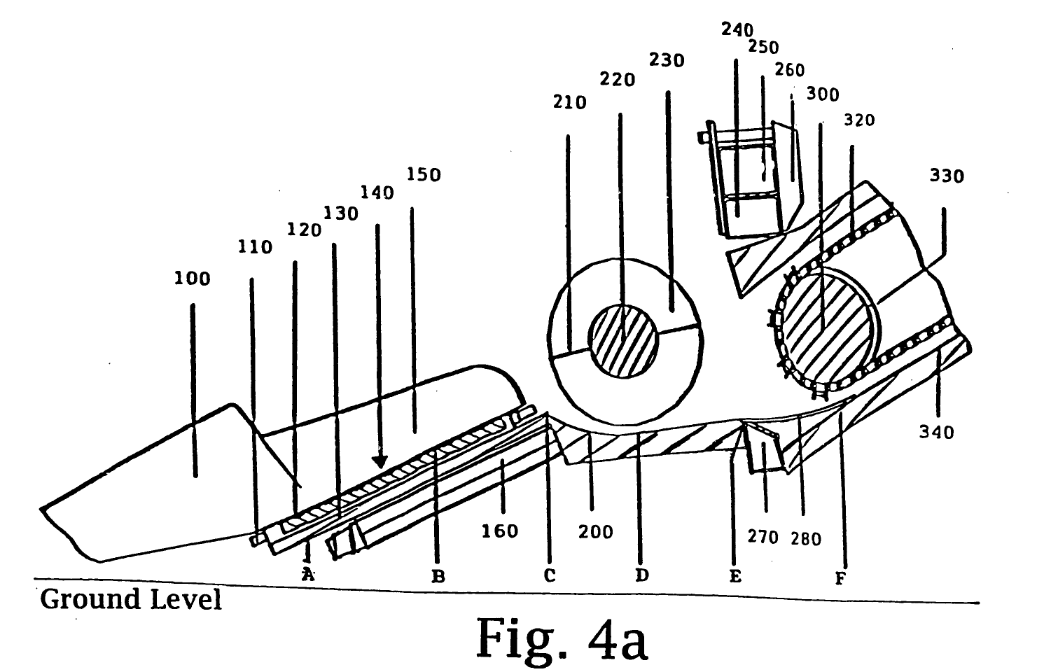

This motion must overcome gravity, friction, and the weight of the material being pushed by a force that is not totally in line with the direction of the movement desired, as is the case of force and movement when it reaches the feeder house chain 320. This invention, as taught in patent application Ser. No. 09/827,563 and shown in FIGS. 4, 4a, 5 and 6 spatially realigns specifically the cross auger trough 200 and the cross auger portions of the header 220 and the entry to the feeder house 340. There is a resultant improved movement of material with the same power by this realignment.

Through testing and use, it has been found that minimizing the downward curvature of the inlet of said auger trough 200 so that the downward angle does not exceed five (5) degrees, approximately, while also minimizing the upward curvature of the inlet of said auger trough 200 to also not exceed five (5) degrees, approximately and minimizing the difference in height between the height of the entrance to the feeder house 340 system in relation to the height of said auger trough 200, reduces the angle of the inclined plane surface from said the auger trough 200 (also referred to as the second conveyor system) to the feeder house 340 and feeder house chain 320 (also referred to as the third conveyor system).

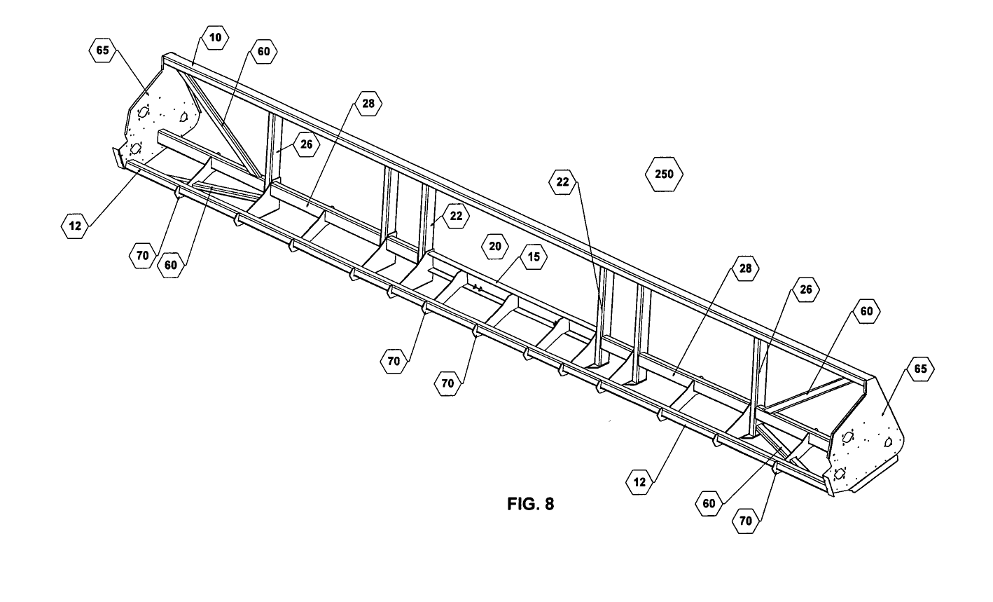

The spatial realignment method and apparatus taught in patent application Ser. No. 09/827,563 provides for reduced energy requirements for propelling the crop through the corn head or to assist in propelling the crop in its movement from the cross auger trough 200 to the feeder house 340 where it is engaged by the feeder house chain 320 and slats 310 for further powered movement. This realignment is accomplished as shown in FIG. 4, 4a, 5, and 6 by inserting a vertical spacer 240 or 255 to elevate the header bar 250 vertically. The spacer 240 is attached to the corn head frame 250 by means of a bracket 260 which may be held by similar and any well-known fastening means to secure 250 and 260 together. Vertical spacers 245 and 255 are also attached by well-known fasteners, examples of which are found in FIGS. 8-22.

In FIG. 4 and 4a, when the vertical spacer is inserted the entire corn head is lifted vertically so that the flighting 230 and paddles 210 will possibly interfere with the feeder house chain 320. Thus to permit the raising of the entire corn head, point E must be moved laterally in a direction away from the feeder house chain 320. This movement is accomplished by the insertion of a lateral spacer 270 between the auger trough 200 and frame of the feeder house 340 at its lowest portion. To maintain lateral spacer 270 in its position a fastening means must be provided. Lateral spacer 270 may be fastened to the cross auger 200 trough by any well-known means such as bolts or welding.

In order to prevent discharge of the material onto the ground through the void created by insertion of lateral spacer 270 a flexible or rigid filler plate 280 must be inserted between the cross auger trough 200 and the feeder house tray 340 and attached with common fasteners.

FIG. 4a shows the invention with lowering only to the aft portion of auger trough 200 in front of feeder house 340. A further embodiment of this invention is shown in FIG. 5 wherein the function of the lateral spacer 270 and vertical spacers 240 or 255 are combined in one unit as trapezoidal spacer 245. This trapezoidal spacer 245 is formed as shown in FIG. 5 so that it both horizontally and vertically changes the spatial relationship between the feeder house 340 and the exit of cross auger floor 200. This embodiment could be done if it is desirable with different combine headers to move the auger flighting 230 closer to the feeder house chain 320. A flexible filler plate 280 is still necessary, which then forms a cylindrical surface to be swept by the path of the feeder house conveyor chain 320. A fastening member is provided to hold the cross auger trough 200 and the feeder house 340 together by a fastener means 205 to ensure that the members remain in position at all time, including park.

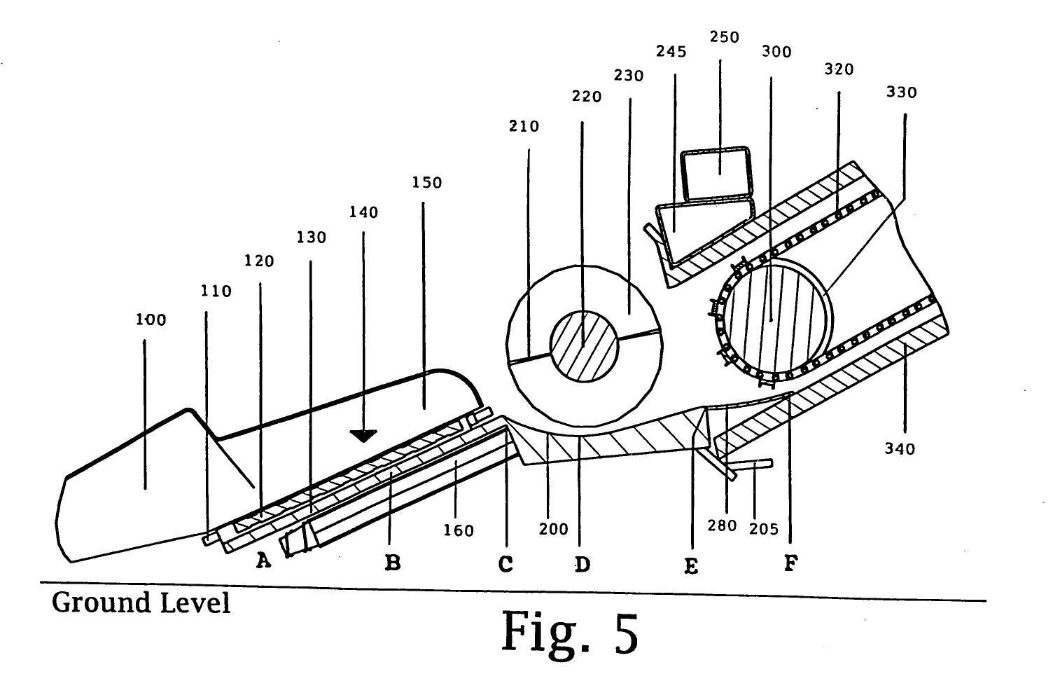

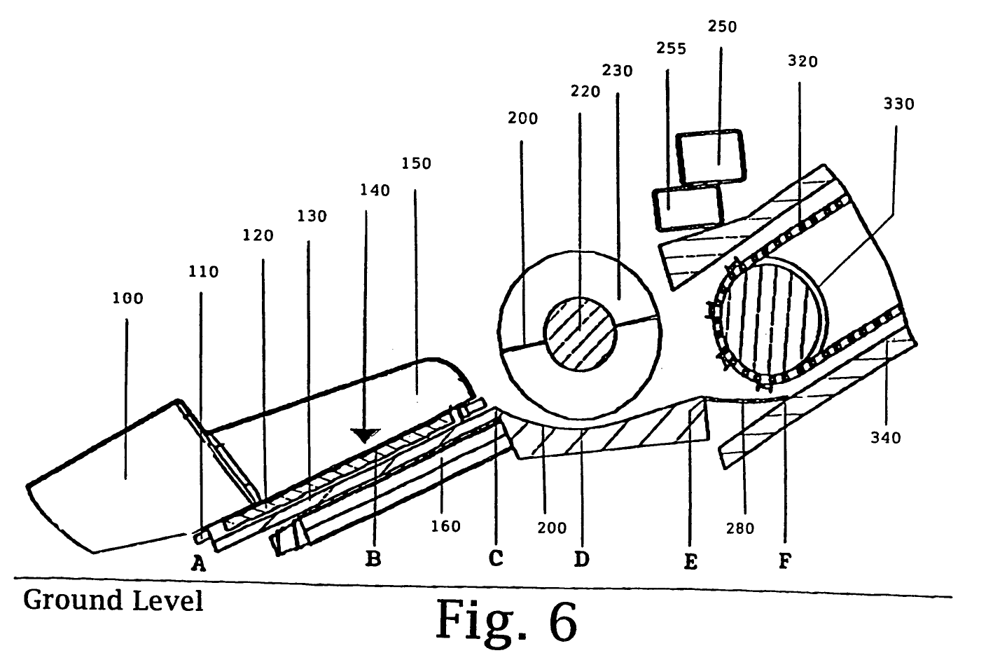

A further embodiment is shown in FIG. 6 wherein the vertical spacer 255 is inserted between the frame 250 and the feeder house 340. This vertical spacer 255 is fastened to the corn head frame 250 in the same manner as vertical spacer 240 in FIG. 4. There is also shown in FIG. 6 the flexible feeder plate 280, which conforms to the cylindrical path swept by the feeder house chain 320. The flexible feeder plate 280 also maintains a seal between the trough 200 and the feeder house 340 during lateral tilt.

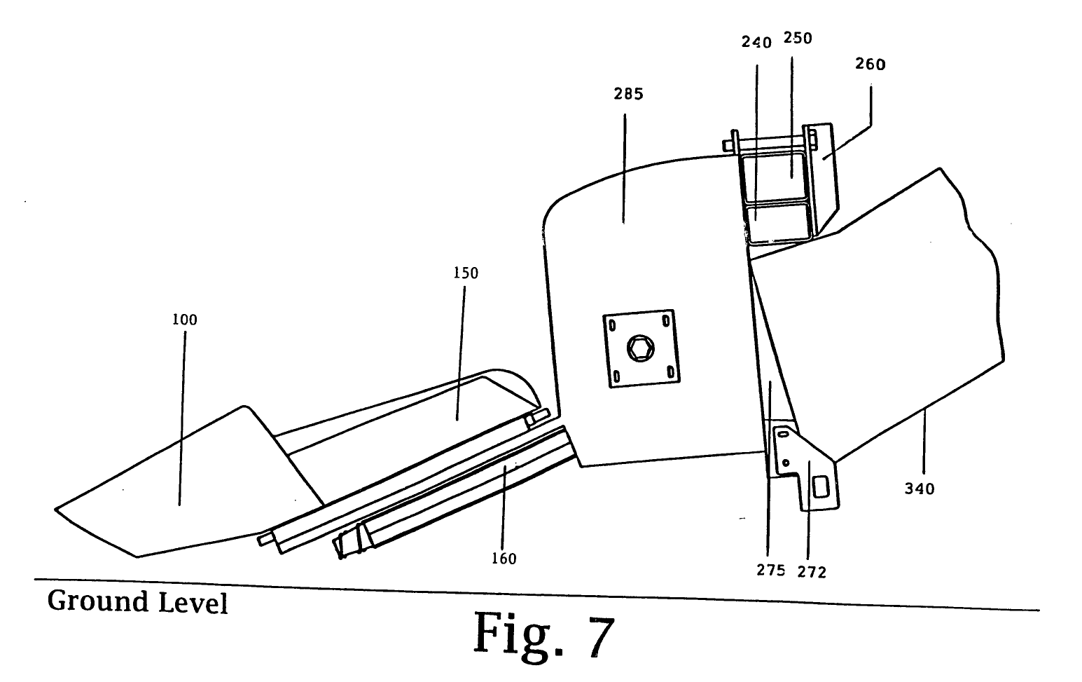

FIG. 7 is an end view of the invention showing the vertical spacer 240, frame member 250, feeder house 340, and the filler plate 275 between the feeder house 340 and the rear vertical wall of the cross auger trough 200. The corn head and feeder house are connected by fastening means 272 to ensure that they remain in position at all times including park.

FIGS. 8-22 generally shows the method and apparatus for universal selection of a corn head for attachment to a combine. FIGS. 8 and 9 provide isometric views of the universal corn head frame 250 from the row unit 80 and combine feeder house 340 attachment sides, respectively. The corn head mounting frame system is compromised of a top horizontal beam 10 and a lower horizontal cross beam 12. The top beam 10 serves as the supporting skeleton or structure for assembly of the rest of the corn head frame 250. As shown by FIGS. 8 and 9, the top beam 10 and the breast plate 15 are aligned in the same plane and are parallel to each other and when combined with the feeder house towers 22 on each side form the universal frame feeder house opening 20. After creation of the universal frame feeder house opening 20 the rest of the corn head frame 250 is built by first attaching frame towers 26 along the length of the top beam 10. Tower crosses 28 are then connected to the frame towers 26 and opposite to the top beam 10. As shown in FIGS. 9 the spacing between frame towers 26 and the feeder house towers 22 is reduced to increase support in the middle of the corn header frame 250 and reduce flex. Thereafter, the spacing between the frame towers 26 to the end of the top beam is equal to evenly distribute the supports along the top beam 10. Connection of foot plate 70 along the length of both the breast plate 15 and the frame tower crosses 28 bridges the support for the mounting and combine attachment side of the corn head, seen in FIG. 9, to the row unit 80 attachment side of the corn head frame 250 as seen in FIG. 8 at multiple points along the length of the corn head frame lower beam 12. Further distribution and support for both the upper and lower beams is provided by knee braces 60. Finally, side plates 65 connected at each end of the top beam 10, the lower beam 12 and the outer cross beams 28 support and maintain the spatial arrangement of the three components while enclosing the ends of the corn head frame 250.

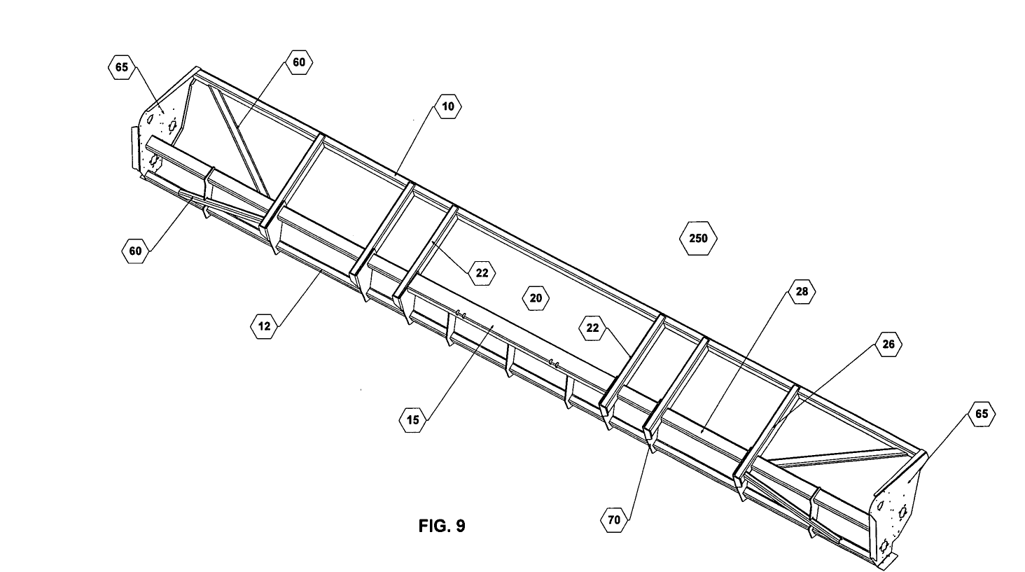

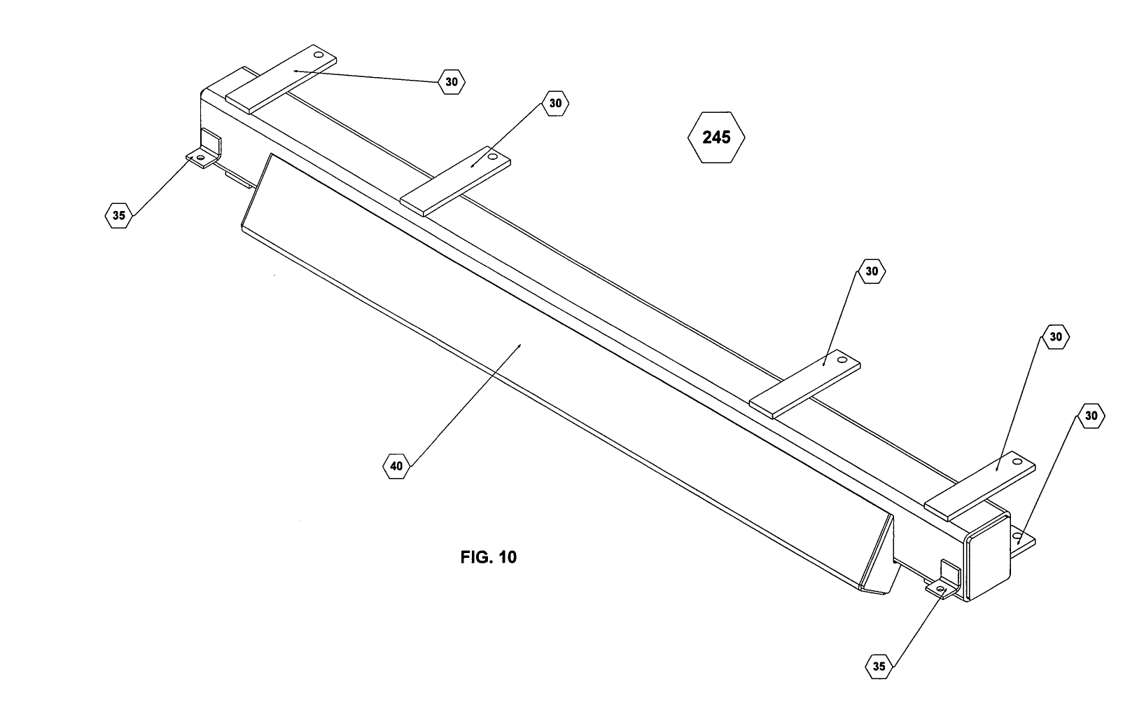

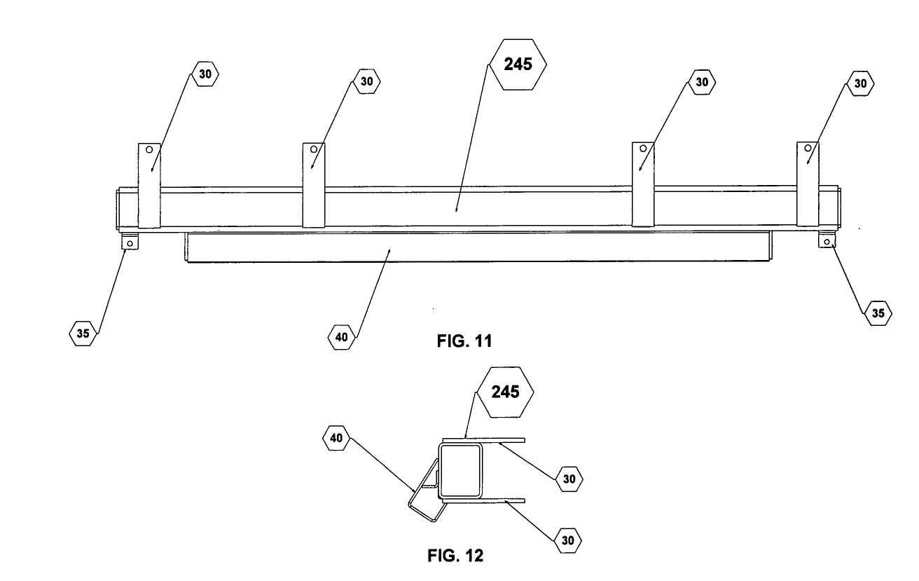

FIGS. 8-9 depict the universal frame header which is the subject of this invention. FIGS. 10-19 show one embodiment of this invention as implemented to attach a corn head to a combine manufactured by Case International®. FIG. 10 provides an isometric view of the vertical spacer 245 for the universal corn head mounting system and apparatus as taught by the inventor. Spacer braces 30 and spacer clips 35 attached to vertical spacer 245 create a cradle like mount for attachment to the underside of top beam 10. Insertion and attachment of the vertical spacer 245 onto the bottom side of the corn head frame top beam 10 strategically aligns the corn head with the combine for attachment and improved flow through the cross auger trough 200, feeder house opening 20 and into the combine feeder house 340 and combine. See FIG. 5 showing the head attached to a combine using vertical spacer 245. FIGS. 11 and 12 provide front and end views, respectively, of the vertical spacer 245 shown in FIG. 10.

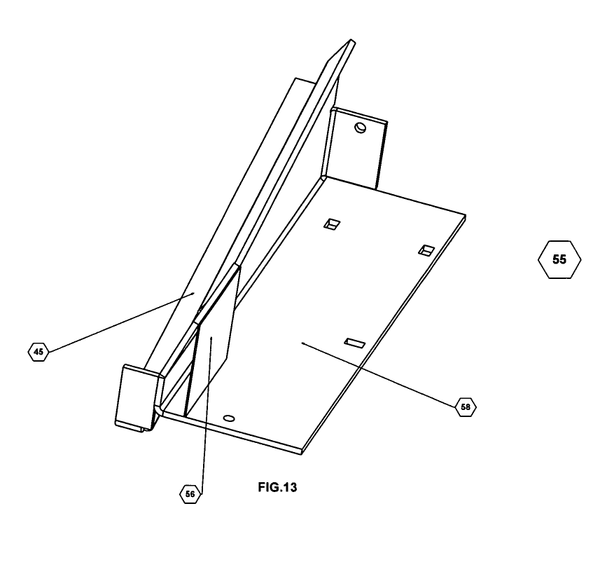

FIG. 13 is an isometric view of the side filler plate 55 used with the vertical spacer 245 embodiment shown in FIG. 10. Side filler plates 55 are attached at mounting plate 58 within the corn head on either side of the feeder house frame opening 20 to provide a virtually solid and continuous transitional wall between the corn head frame and the feeder house 340 to prevent loss of corn material. Side filler plate support 56 reduces the flex of the side filler plate 55 and in combination with preformed back wall plate 45 surrounds the feeder house frame opening 20. The combined installation of the vertical spacer 245 with side filler plate 55 and preformed back wall plate 45 into a corn head frame having a universal feeder house frame opening 20 provides a substantially custom fit attachment method and apparatus adaptable to any model or make of combine requiring the switching of only a few parts. FIGS. 14 and 15 provides a front and end view, respectively, of the side filler plate 55 as shown in FIG. 13.

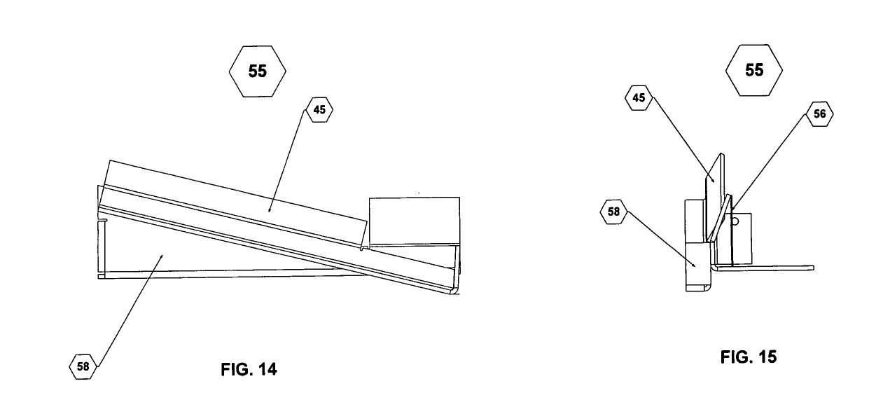

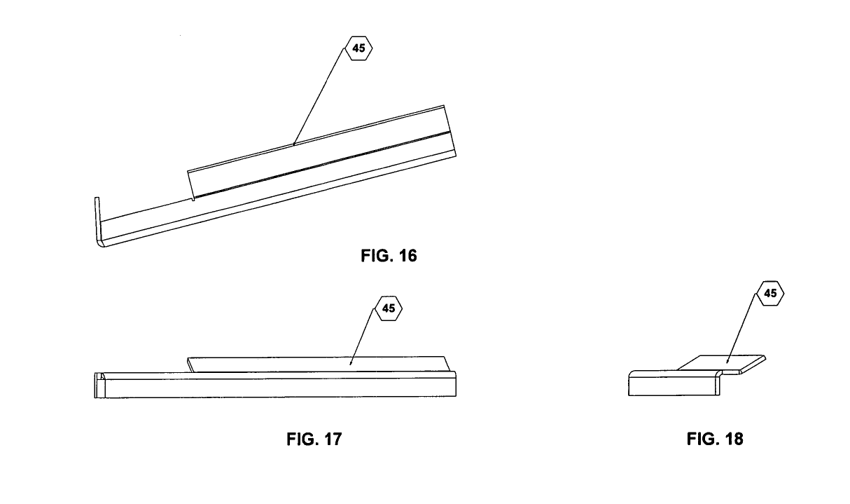

FIG. 16 provides an isometric view of the preformed back wall plate 45 used with the embodiment shown in FIG. 10 while FIGS. 17 and 18 show front and side views of the preformed back wall plate 45 used with the embodiment shown in FIG. 10.

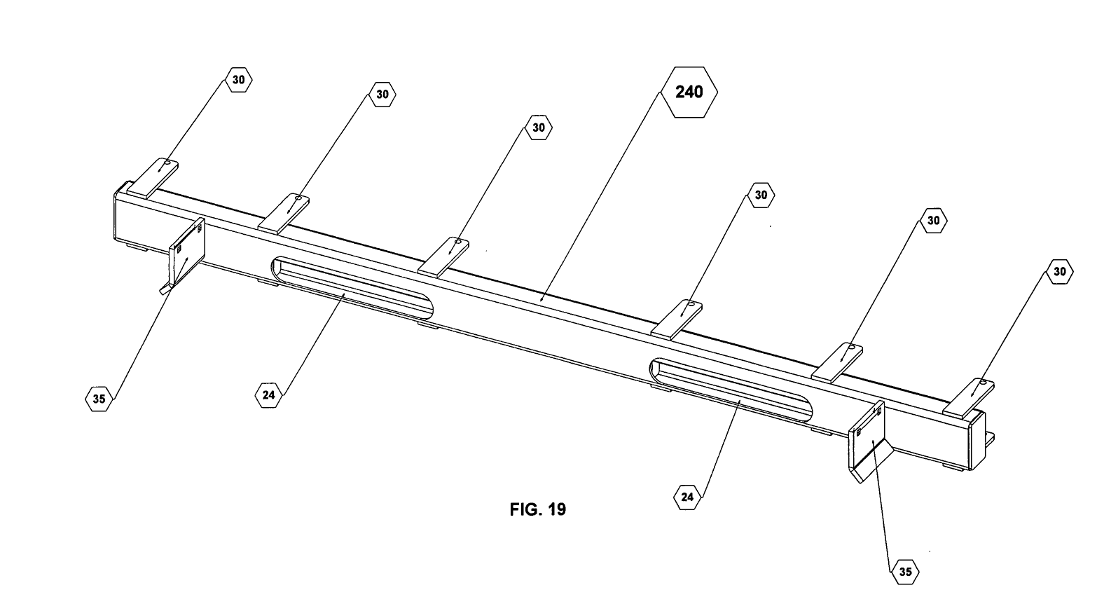

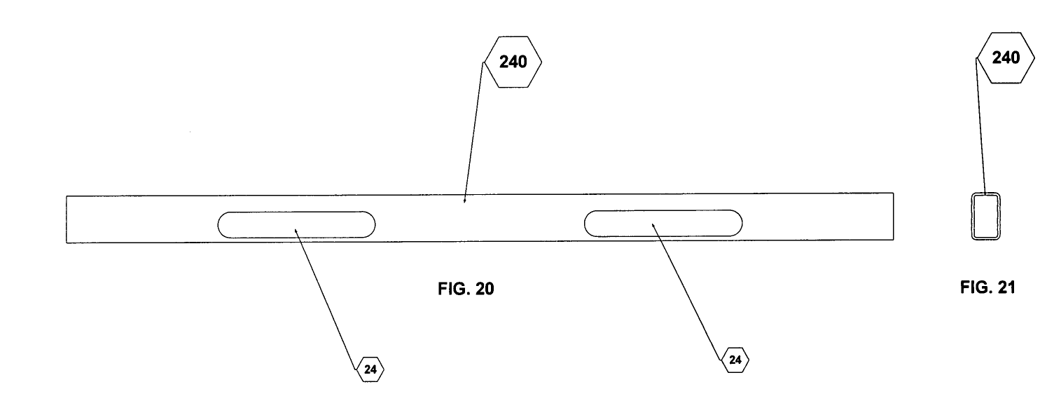

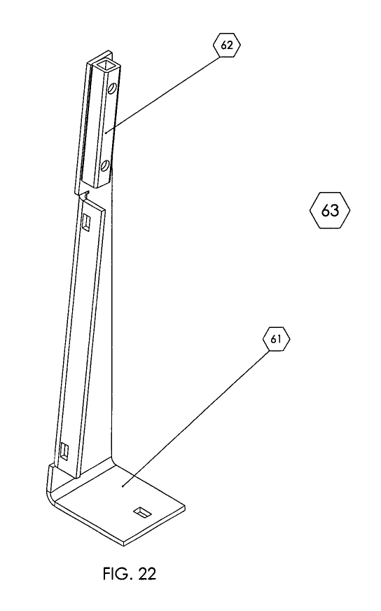

FIGS. 19-22 show another embodiment of this invention as implemented to attach a corn head to a combine manufactured by John Deere®. FIG. 19 provides an isometric view of another embodiment of the vertical spacer 240 for the universal corn head mounting system and apparatus as taught by the inventor. Similar to the teachings for in FIGS. 10-12, the arrangement of spacer braces 30 and spacer clips 35 around the perimeter of vertical spacer 240 shown in FIG. 19 allow a cradle like attachment of vertical spacer 240 to the underside of top beam 10. As shown in FIG. 19, the vertical spacer design chosen and taught by the inventor allows further modification for attachment of the corn head to the combine. In this particular embodiment, the mounting recesses 24 shown in FIG. 19 are of the type found on most late model John Deere® combines. FIG. 20 provides a front view of vertical spacer 240 without the spacer brackets 30 and clips 35 shown. FIG. 21 is a side view of the embodiment shown in FIG. 19 without brackets. FIG. 22 provides an isometric view of the side filler plates 63 used with, and placed on both sides of, the embodiment of the vertical spacer 240 shown in FIG. 19. Side filler plate horizontal mount 62 allows attachment of the bottom of the side filler plates 63 to the top of the breast plate 15 while side filler plate vertical mount 62 allows attachment to the lower side of the vertical spacer 240. The arrangement and attachment of vertical spacer 240 and side filler plates 63 surround and enclose the universal feeder house frame opening 20. The combined installation of the vertical spacer 240 with side filler plate 63 into a corn head frame having a universal feeder house frame opening 20 provides a substantially custom fit attachment method and apparatus adaptable to any model or make of combine requiring the switching of only a few parts.

Having described the preferred embodiment, other features of the present invention will undoubtedly occur to those versed in the art, as will numerous modifications and alterations in the embodiments of the invention illustrated, all of which may be achieved without departing from the spirit and scope of the invention.

1. A corn head mounting frame system allowing universal selection of a combine comprising the following elements:
a. A top horizontal cross beam;
b. A bottom right horizontal cross beam;
c. A bottom left horizontal cross beam; said right and left bottom horizontal cross beams approximately the same length; said top and bottom horizontal cross beams in parallel arrangement to each other and vertically spaced at least thirty-six inches apart;
d. A breast plate having two sides; said front side being channel shaped for insertion of a foot plate for supporting a lower front beam positioned in parallel with said horizontal cross beam;
e. A right interior vertical beam;
f. A left interior vertical beam; said right and left beams in parallel and horizontally spaced at least forty-four inches apart; said top and bottom horizontal cross beams connected to said vertical beams and at right angles to said horizontal cross beams;
g. A universal frame feeder house box having a generally rectangular shape and created by the intersection and connection of said vertical interior beams with said top horizontal beam and said breast plate;
h. A vertical spacer having a bottom side adapted to engage the upper anterior exterior portion of the selected combine feeder house; said vertical spacer sized for engaged insertion with and below said top horizontal cross beam;
i. A right exterior vertical beam positioned between the right internal vertical beam and the right end of said top and bottom horizontal cross beams;
j. A left exterior vertical beam positioned between the left internal vertical beam and the left end of said top and bottom horizontal cross beams; said left and right exterior beams connected to said top and bottom horizontal cross beams;
k. A left side filler wall plate connected between said top and bottom horizontal cross beams; said side filler wall plate selected for the width of the selected combine feeder house;
l. A right side filler wall plate connected between said top and bottom horizontal cross beams; said side filler wall plate selected for the width of the selected combine feeder house;
m. A right side end plate, said right side end plate connected to the right end of said top, bottom and lower horizontal cross beams; and,
n. A left side end plate, said right side end plate connected to the left end of said top, bottom and lower horizontal cross beams.

2. The invention according to claim 1 further comprising a plurality of left and right exterior vertical beams connected to the top and bottom cross beams as necessary to support the outer frame for increased beam length and head or platform width.

3. The invention according to claim 1 wherein said vertical spacer has vertical legs for engaged insertion with said top horizontal cross beam.

4. The invention according to claim 1 wherein said top edge of said left or right side filler back wall plate is adapted for slideable insertion with and upon said top horizontal cross beam.

5. A method to improve the arrangement of and spatial relationship between the functional elements of a row crop harvester attachment or header unit for mounting on and co-acting with the functional elements of a mobile threshing unit, wherein the functional elements include:
(i) a row crop harvester having a main frame attachment mounted to a mobile harvesting threshing unit;
(ii) a first conveyor system in said row crop harvester including a power source, said power source connected to a plurality of row units mounted on said main frame for removing grain from the stalks and conveying the material including grain up a first inclined plane to exits from said first conveyor system;
(iii) a second conveyor system, at right angles to said first conveyor system, including a power source for receiving the harvested material from the exits of said first conveyor system, said second conveyor system cooperating with and above a curved auger trough surface;
(iv) said second conveyor system conveying said material from the exits of said first conveyor system to an area at the center of the plurality of row units for exit from said second conveyor system;
(v) an open area between the exit of the second conveyor system and the entrance of the mobile threshing unit connecting said second conveyor system and mobile threshing unit;
(vi) a third conveyor system, including a power source, in said mobile threshing unit for retrieving material in said open area and delivering the material to the thresher mechanism, wherein the improved method is comprised of:
(a) minimizing the downward curvature of the inlet of said auger trough, said downward angle to not exceed five (5) degrees,
(b) minimizing the upward curvature of the inlet of said auger trough, said upward angle to not exceed five (5) degrees, and,
(c) minimizing the difference in height between the height of the entrance to the third conveyor system in relation to the height of said second conveyor system, said difference in height reducing the angle of the inclined plane surface from said second conveyor system to said third conveyor system.

6. The method of claim 5, wherein a feeder plate is attached to said second conveyor system for bridging between said second conveyor system and said third conveyor system to reduce the distance and incline plane between said second and third conveyor systems and prevent the build-up of harvested material between said conveyor systems.

7. The method of claim 5, wherein an improved apparatus of constructing a corn head mounting frame system allows for universal selection of a combine, the invention further comprising the following elements:
a. A top horizontal cross beam;
b. A bottom right horizontal cross beam;
c. A bottom left horizontal cross beam; said right and left bottom horizontal cross beams approximately the same length; said top and bottom horizontal cross beams in parallel arrangement to each other and vertically spaced at least thirty-six inches apart;
d. A breast plate having two sides; said front side being channel shaped for insertion of a foot plate for supporting a lower front beam positioned in parallel with said horizontal cross beam;
e. A right interior vertical beam;
f. A left interior vertical beam; said right and left beams in parallel and horizontally spaced at least forty-four inches apart; said top and bottom horizontal cross beams connected to said vertical beams and at right angles to said horizontal cross beams;
g. A universal frame feeder house box having a generally rectangular shape and created by the intersection and connection of said vertical interior beams with said top horizontal beam and said breast plate;
h. A vertical spacer having a bottom side adapted to engage the upper anterior exterior portion of the selected combine feeder house; said vertical spacer sized for engaged insertion with and below said top horizontal cross beam;
i. A right exterior vertical beam positioned between the right internal vertical beam and the right end of said top and bottom horizontal cross beams;
j. A left exterior vertical beam positioned between the left internal vertical beam and the left end of said top and bottom horizontal cross beams; said left and right exterior beams connected to said top and bottom horizontal cross beams;
k. A left side filler wall plate connected between said top and bottom horizontal cross beams; said side filler wall plate selected for the width of the selected combine feeder house;
l. A right side filler wall plate connected between said top and bottom horizontal cross beams; said side filler wall plate selected for the width of the selected combine feeder house;
m. A right side end plate, said right side end plate connected to the right end of said top, bottom and lower horizontal cross beams; and,
n. A left side end plate, said right side end plate connected to the left end of said top, bottom and lower horizontal cross beams.

8. The invention according to claim 7 further comprising a plurality of left and right exterior vertical beams connected to the top and bottom cross beams as necessary to support the outer frame for increased beam length and head or platform width.

9. The invention according to claim 8 wherein said vertical spacer has vertical legs for engaged insertion with said top horizontal cross beam.

10. The invention according to claim 9 wherein said top edge of said left or right side filler back wall plate is adapted for slideable insertion with and upon said top horizontal cross beam.

11. The invention according to claim 7 wherein said vertical spacer has vertical legs for engaged insertion with said top horizontal cross beam.

12. The invention according to claim 1 wherein selection of said vertical spacer determines the side and back plates necessary to adapt and attach a corn head to a combine.

13. A corn head mounting frame system allowing universal selection of a combine comprising the following elements:
a. A top horizontal cross beam;
b. A bottom right horizontal cross beam;
c. A bottom left horizontal cross beam; said right and left bottom horizontal cross beams approximately the same length; said top and bottom horizontal cross beams in parallel arrangement to each other and vertically spaced a fixed distance apart;
d. A breast plate having two sides;
e. A right interior vertical beam;
f. A left interior vertical beam; said right and left beams in parallel and horizontally spaced a fixed distance apart; said top and bottom horizontal cross beams connected to said vertical beams and at right angles to said horizontal cross beams;
g. A universal frame feeder house box having a generally rectangular shape and created by the intersection and connection of said vertical interior beams with said top horizontal beam and said breast plate;
h. A vertical spacer having a bottom side adapted to engage the upper anterior exterior portion of the selected combine feeder house; said vertical spacer sized for engaged insertion with and below said top horizontal cross beam;
i. A right exterior vertical beam positioned between the right internal vertical beam and the right end of said top and bottom horizontal cross beams;
j. A left exterior vertical beam positioned between the left internal vertical beam and the left end of said top and bottom horizontal cross beams; said left and right exterior beams connected to said top and bottom horizontal cross beams;
k. A left side filler wall plate connected between said top and bottom horizontal cross beams; said side filler wall plate selected for the width of the selected combine feeder house;
l. A right side filler wall plate connected between said top and bottom horizontal cross beams; said side filler wall plate selected for the width of the selected combine feeder house and in combination with said left side filler plate, encloses the area between said feeder house opening and the corn head;
m. A right side end plate, said right side end plate connected to the right end of said top, bottom and lower horizontal cross beams; and,
n. A left side end plate, said right side end plate connected to the left end of said top, bottom and lower horizontal cross beams.

14. The invention according to claim 12 wherein selection of said vertical spacer determines the side and back plates necessary to adapt and attach a corn head to a combine.

15. The invention according to claim 13 further comprising a plurality of left and right exterior vertical beams connected to the top and bottom cross beams as necessary to support the outer frame for increased beam length and head or platform width.

16. The invention according to claim 15 wherein said vertical spacer has vertical legs for engaged insertion with said top horizontal cross beam.

17. The invention according to claim 16 wherein said top edge of said left or right side filler back wall plate is adapted for slideable insertion with and upon said top horizontal cross beam.

18. The invention according to claim 13 wherein said vertical spacer has vertical legs for engaged insertion with said top horizontal cross beam.

19. A method of constructing corn heads allowing for universal selection of a combine for attachment to the corn head compromising the following steps:
a. Constructing a header frame having a universal feeder house opening;
b. Selecting and attaching a vertical spacer components dependent on the combine to be attached to the corn head; and,
c. Selecting and attaching side and back wall components dependent on the vertical spacer component and combine selected for attachment.

20. The method of constructing corn heads further selected to improve the arrangement of and spatial relationship between the functional elements of a row crop harvester attachment or header unit as described in claim 19, for mounting on and co-acting with the functional elements of a mobile threshing unit, wherein the functional elements include:
a. a row crop harvester having a main frame attachment for mounting to a mobile harvesting threshing unit;
b. a first conveyor system in said row crop harvester including a power source, said power source connected to a plurality of row units mounted on said main frame for removing grain from the stalks and conveying the material including grain up a first inclined plane to exits from said first conveyor system;
c. a second conveyor system, at right angles to said first conveyor system, including a power source for receiving the harvested material from the exits of said first conveyor system, said second conveyor system cooperating with and above a curved auger trough surface;
d. said second conveyor system conveying said material from the exits of said first conveyor system to an area at the center of the plurality of row units for exit from said second conveyor system;
e. an open area between the exit of the second conveyor system and the entrance of the mobile threshing unit connecting said second conveyor system and mobile threshing unit;
f. a third conveyor system, including a power source, in said mobile threshing unit for retrieving material in said open area and delivering the material to the thresher mechanism, wherein the improved method is comprised of:
i. minimizing the downward curvature of the inlet of said auger trough, said downward angle to not exceed five (5) degrees,
ii. minimizing the upward curvature of the inlet of said auger trough, said upward angle to not exceed five (5) degrees, and,
iii. minimizing the difference in height between the height of the entrance to the third conveyor system in relation to the height of said second conveyor system, said difference in height reducing the angle of the inclined plane surface from said second conveyor system to said third conveyor system.

21. The method of claim 1, wherein a feeder plate is attached to said second conveyor system for bridging between said second conveyor system and said third conveyor system to reduce the distance and incline plane between said second and third conveyor systems and prevent the build-up of harvested material between said conveyor systems.
